(19) United States
(12) Patent Application Publication
(10) Pub. No.: US 2024/0200953 A1
(43) Pub. Date: Jun. 20, 2024

(54) VISION BASED COOPERATIVE VEHICLE LOCALIZATION SYSTEM AND METHOD FOR GPS-DENIED ENVIRONMENTS

(71) Applicant: Continental Autonomous Mobility US, LLC, Auburn Hills, MI (US)

(72) Inventors: Julien Ip, Royal Oak, MI (US); Eduardo Jose Ramirez Llanos, Rochester, MI (US); Matthew Donald Berkemeier, Beverly Hills, MI (US)

(73) Assignee: Continental Autonomous Mobility US, LLC, Auburn Hills, MI (US)

(21) Appl. No.: 18/556,817

(22) PCT Filed: Apr. 22, 2022
(86) PCT No.: PCT/US2022/071862

§ 371 Date: Oct. 23, 2023

Related U.S. Application Data
(60) Provisional application No. 63/201,303, filed on Apr. 22, 2021.

(51) Int. Cl. G01C 21/30; G06T 7/73; G06V 20/58

(52) U.S. Cl. CPC G01C 21/30; G06T 7/73; G06V 20/58; G06T 2207/30252; G06V 2201/08

(57) ABSTRACT

A vehicle localization method, system and program code product for a vehicle is disclosed. The method includes capturing image data from at least one camera disposed on a vehicle. A representation of a second vehicle in the image data is identified. Location information corresponding to the second vehicle is received from the second vehicle. Location information for the vehicle is determined or updated location based on the representation of the second vehicle in the image data and the location information for the second vehicle.

### TECHNICAL FIELD

The present disclosure relates to vehicle positioning systems, and more specifically to vehicle positioning systems for determining a position of each of a plurality of vehicles in the absence of an external signals and information.

### BACKGROUND

Vehicles global positioning system utilizes external signals broadcast from a constellation of GPS satellites. The position of a vehicle is determined based on the received signals for navigation and increasingly for autonomous vehicle functions. In some instances, a reliable GPS signal may not be available. However, autonomous vehicle functions still require sufficiently precise positioning information.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vehicle localization system, method and software program product for a vehicle are disclosed. The system includes a camera disposed on a vehicle for reading an optic label disposed on fixed object and capturing an image of a shape also disposed on the fixed object. A controller is configured to update location information of the vehicle based on perspective dimensions of the shape captured by the camera and actual dimensions of the shape read from the optic label, and to share the location information of the vehicle with one or more neighboring vehicles.

The optic label includes coordinates of the fixed object and the controller is operable to determine a position of the vehicle based on a determined distance and orientation of the vehicle relative to the fixed object and the coordinates of the fixed object, the location information comprising the position of at least one visible feature of the vehicle.

The controller is further configured to receive location information from one or more of the neighboring vehicles, identify in image data from the camera of a representation of the one or more neighboring vehicles, and selectively further update the location information of the vehicle based upon the location information received from the one or more of the neighboring vehicles and the representation of the one or more neighboring vehicles.

The controller is further configured to determine whether or not to update the location information of the vehicle based upon the location information received from the one or more of the neighboring vehicles, and the further update of the location information of the vehicle is in response to the determination of whether or not to update the location information of the vehicle.

The location information from the one or more of the neighboring vehicles is relative to a second fixed object having an optic label disposed thereon.

The location information includes a local map of a region of interest surrounding the fixed object, the region of interest being larger than the fixed object.

The controller is further configured to receive from the fixed object second location information of the vehicle relative to the fixed object, the second location information comprising distance information between the fixed object and the vehicle as measured by the fixed object, and to selectively update the location information based upon the second location information.

The controller includes or is associated with non-transitory memory having program code instructions which, when executed by the controller, causes the controller to update the location information and to share the updated location information with the neighboring vehicles.

A vehicle localization program code product is stored in non-transitory memory having instructions which, when executed by a controller having a processor, causes the controller to perform a method. In an example embodiment, the method includes capturing image data from at least one camera disposed on a vehicle. The method further includes identifying a representation of a second vehicle in the image data. Location information corresponding to the second vehicle is received from the second vehicle. Location information of the vehicle is determining or updated based on the representation of the second vehicle in the image data and the location information for the second vehicle.

In the program code product, the image data includes a shape of a representation of a fixed object, wherein updating location information of the vehicle is based on perspective dimensions of the shape of the fixed object representation captured by the camera and actual dimensions of the shape read from an optic label disposed on the fixed object; and wherein the method further includes sharing the location information of the vehicle with one or more neighboring vehicles, the location information comprising location information of at least one visible feature of the vehicle.

The location information includes a local map of a region of interest surrounding the fixed object, the region of interest being larger than the fixed object.

The method performed by the program code product further includes determining whether or not to update the location information of the vehicle based upon the location information received from the second vehicle, and updating the location information of the vehicle in response to the determination of whether or not to update the location information of the vehicle.

The location information of the second vehicle includes localization information for a visible feature of the second vehicle.

The performed method further comprises sharing the location information of the vehicle with one or more neighboring vehicles.

In another example embodiment, a vehicle localization method for a vehicle includes capturing image data from at least one camera disposed on a vehicle; and identifying a representation of a second vehicle in the image data. Location information corresponding to the second vehicle is received from the second vehicle. Location information of the vehicle is determined or updated based on the representation of the second vehicle in the image data and the location information for the second vehicle.

The image data includes a shape of a representation of a fixed object, wherein updating location information of the vehicle is based on perspective dimensions of the shape of the fixed object representation captured by the camera and actual dimensions of the shape read from an optic label disposed on the fixed object, and wherein the method further includes sharing the location information of the vehicle with one or more neighboring vehicles.

The location information of the second vehicle includes localization information for a visible feature of the second vehicle.

The method further includes sharing the location information of the vehicle with one or more neighboring vehicles.

### BRIEF DESCRIPTION OF THE DRAWINGS

FIG. 1 is a schematic view of an example roadway and sign including position and dimension information embedded in a machine-readable optical label.

FIG. 2 is a schematic representation of an example method of determining vehicle position according to an embodiment.

FIG. 3 is a schematic top view of a vehicle with rear facing camera relative to a sign.

FIG. 4 is a schematic view of a sign with five points and embedded coordinates.

FIG. 5 is an image showing corresponding image points after using a fisheye camera model.

FIG. 6 depicts a flowchart illustrating an operation of a vehicle positioning determining system according to an example embodiment.

FIG. 7 depicts a group of vehicles including a master vehicle and slave vehicles according to an example embodiment.

### DETAILED DESCRIPTION

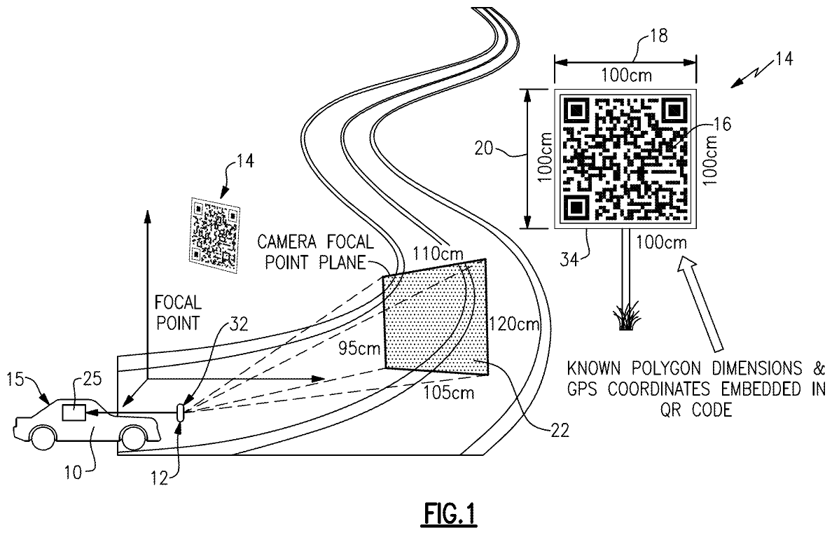

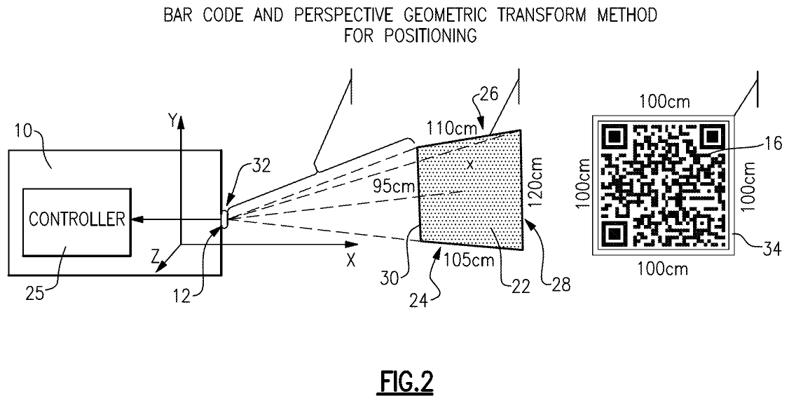

Referring to FIG. 1, a vehicle 10 is shown schematically along a roadway. The vehicle 10 includes a vehicle positioning system 15 that reads information from a machine-readable optic label disposed on a fixed object. The optic label includes information regarding the coordinate position of the fixed object and dimensions of a visible symbol or shape on the fixed object.

The vehicle 10 includes a controller 25 that uses the communicated dimensions to determine a relative position of the vehicle relative to the fixed object 14. The position of the fixed object is communicated by the coordinates provided within the optic label 16. The position of the vehicle 10 relative to the fixed object is determined based on a difference between the communicated actual dimensions of the visible symbol and dimensions of an image of the visual symbol captured by a camera disposed on the vehicle.

Accordingly, the example disclosed vehicle positioning system 15 enables a determination of a precise vehicle positon without an external signal. In cases where GPS radio signals are not accessible (urban settings, forests, tunnels and inside parking structures) there are limited ways to precisely identify an object' position. The disclosed system 15 and method provides an alternative means for determining a position of an object.

In the disclosed example, vehicle 10 includes at least one camera 12 that communicates information to a controller 25. It should be understood that a device separate from the camera 12 may be utilized to read the optic label. Information from the camera 12 may be limited to capturing the image 22 of the polygonal shape 34. The example controller 25 may be a stand-alone controller for the example system and/or contained in software provided in a vehicle controller. The camera 12 is shown as one camera, but may be multiple cameras 12 disposed at different locations on the vehicle 10. The camera 12 gathers images of objects along a roadway.

The example roadway includes a fixed structure, such as for example a road sign 14. The example road sign 14 includes a machine-readable optic label 16 that contains information regarding the location of the road sign 14. The optic label 16 further includes information regarding actual dimensions of a visible symbol 34. In this disclosed example, the visible symbol is a box 34 surrounding the optic label 16. The information regarding the box 34 includes height 20 and width 18. In this example, the visible symbol is a box 34 with a common height and width 20, 18. However, other polygon shapes with different dimensions could also be utilized and are within the contemplation of this disclosure.

The camera 12 captures an image 22 of the box 34 and communicates that captured image 22 to the controller 25. The size of the captured image 22 will differ from the actual size of the box 34 due to the distance, angle and proximity of the camera 12 relative to the sign 14. The differences between the captured image 22 and the actual size of the box 34 are due to the geometric perspective of the camera 12 relative to the box 34. The controller 25 uses the known dimensions 20, 18 of the box 34, the corresponding dimensions 24, 26, 28 and 30 of the captured images, and the camera's focal point 32 to determine the distance and orientation relative to the sign 14. The distance and orientation are utilized to precisely position the vehicle 12 relative to the sign 14 and thereby a precise set of coordinates. The distance and orientation between the sign and the camera's focal point 32 is determined utilizing projective geometric transformations based on the dimensions of the captured image 22 as compared to the actual dimensions communicated by the optic label 16.

The captured image 22 is a perspective view of the actual box 34. The geometry that results in the dimensions of the captured image 22 resulting from the orientation of the vehicle 10 relative to the actual box 34 are determinable by known and understood predictive perspective geometric transform methods. Accordingly, the example system 15 determines the distance and orientation of the focal point 32 relative to the sign 14 given the perspective view represented by the captured image 22 of the known box 34 geometry.

In this example, the optic label 16 is a QR code or two-dimensional bar code. It should be appreciated, that the optic label 16 may be any type of machine-readable labels such as an example bar code. Moreover, although the example system 16 is disclosed by way of example as part of motor vehicle 10, the example system 15 may be adapted to other applications including other vehicles and hand held devices.

Accordingly, the example disclosed system and method of positioning and localization uses computer readable labels and projective geometry to determine the distance between the camera's focal point and the sign that is then utilized to determine a position of the vehicle. The computer readable image is encoded with a position coordinate (e.g. GPS coordinates) and actual physical dimensions of an accompanying polygon (e.g. bounding box) inside of an encoded computer readable label (e.g. QR or Bar Code) on a sign or fixed surface. The viewing object is able to read and interpret the position coordinate and polygon dimensions and perform a projective geometric transformation using its own perspective dimensions observed of the polygon in conjunction with the known polygon dimensions.

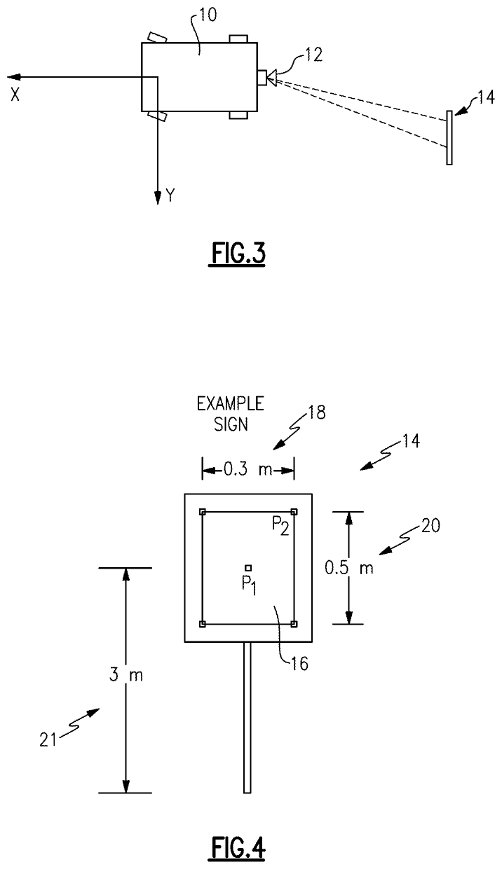

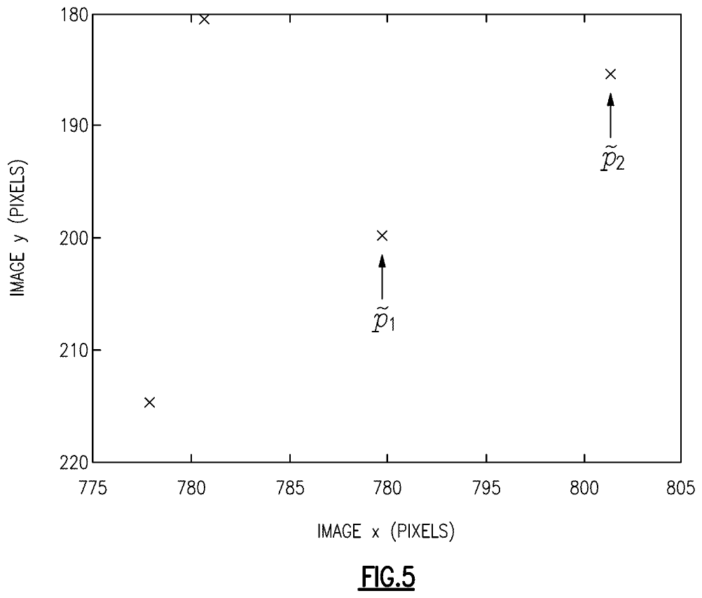

Referring to FIGS. 3 and 4, an example method of localization of a vehicle 10 from a sign 14 with embedded coordinates 16 is schematically shown. The sign 14 includes multiple points known physical dimensions and coordinates. These points are show by way of example as p₁, p₂, . . . , pₙ.

The vehicle 10 has some unknown position and orientation with respect to the world and the sign 14. We can represent this with a position vector p and a rotation matrix R. This combination, (p, R), involves 6 unknown variables (e.g. 3 position components and 3 Euler angles).

The vehicle 10 has a camera 12 which images the points on the sign 14. The points in the image have only 2 components. Let these points be p₁, p₂ . . . pₙ. The indices indicate corresponding sign points (3 components) and image points (2 components).

The camera 12 has some intrinsic and extrinsic parameters. If the camera 12 is calibrated, then these are all known. These will be included in the map P.

A set of equations can be written as shown in the below examples:

$$\begin{matrix}{\tilde{p}}_{1} = P ( p , R , {p}_{1} ) \\ {\tilde{p}}_{2} = P ( p , R , {p}_{2} ) \\ ⋮ \\ {\tilde{p}}_{n} = P ( p , R , {p}_{n} )\end{matrix}$$

The present disclosure relates to vehicle positioning systems, and more specifically to vehicle positioning systems for determining a position in the absence of an external signals and information.

A total of 2n equations and 6 unknowns (p, R). At least three sign points are needed to determine the vehicle position and orientation. In this example disclosed specific embodiment, a fisheye camera is mounted on the rear of a truck. As appreciated, although a fisheye camera is disclosed by way of example, other camera configurations could be utilized and are within the contemplation of this disclosure. Moreover, although the example camera is mounted at the rear of the truck, other locations on the vehicle may also be utilized within the contemplation and scope of this disclosure.

The example truck 10 is located at the origin of a coordinate system, and the vehicle longitudinal axis is aligned with the x-axis. It should be appreciated, that such an alignment is provided by way of example and would not necessarily be the typical case. Note that the example coordinates include latitude, longitude and height, and may be converted to a local Cartesian coordinate system. In this disclosed example, the conversion to a Cartesian coordinate system is done.

In this disclosed example, the sign is 10 m behind the truck (world x=−10). In this example the sign includes 5 points: the center of a rectangle and its 4 corners. The rectangle is 30 cm wide and 50 cm tall.

The setup is illustrated in FIG. 3, where a vehicle “sees” the sign 14 with its rear facing camera 12 (e.g. backup camera). FIG. 4 shows the example sign 14 with the 5 points, which have their world coordinates embedded in the optic label 16. FIG. 5 shows the resulting image points when using the setup described, along with a specific fisheye camera model with specific extrinsic and intrinsic parameters.

Table 1 shows some example data generated by a model of a vehicle with an attached rear camera. In this case, 5 points are included, although more or fewer could be used.

TABLE 1
Example coordinates of 5 points and
corresponding image coordinates.

| Sign Point | World y | World z | Image x | Image y |
|---|---|---|---|---|
| Center | 2 | 3 | 789.7228 | 199.7546 |
| Upper Right | 2.15 | 3.25 | 801.3827 | 185.3372 |
| Lower Right | 2.15 | 2.75 | 798.2733 | 219.1759 |
| Lower Left | 1.85 | 2.75 | 777.8554 | 214.6697 |
| Upper Left | 1.85 | 3.25 | 780.6382 | 180.4325 |

Another disclosed example method of determining a vehicle position with the example system includes a one-shot approach. A one-shot approach enables a determination of the vehicle position/orientation from a single measurement of a sign with multiple known points. As shown in FIG. 4, there are multiple points on the sign with known world coordinates. For example, the sing includes points be p₁, p₂ . . . pₙ.

The vehicle 10 has some unknown position and orientation with respect to the world and the sign. The vehicle position is represented with a position vector p and a rotation matrix R. The combination of the position vector and the rotation matrix, (p, R), provides 6 unknown variables (e.g. 3 position components and 3 Euler angles).

The example vehicle has a camera which images the points on the sign. The points in the image have only 2 components. For example, the points are:
\tilde{p}₁, \tilde{p}₂, . . . , \tilde{p}ₙ

The indices indicate corresponding sign points (3 components) and image points (2 components). The camera 12 has some intrinsic and extrinsic parameters. The example camera 12 is calibrated and therefore the intrinsic and extrinsic parameters are all known. The intrinsic and extrinsic parameters are included in the map P. From the above known parameters, the following set of equations can be written:

$$\begin{matrix}{\tilde{p}}_{1} = P ( p , R , {p}_{1} ) \\ {\tilde{p}}_{2} = P ( p , R , {p}_{2} ) \\ ⋮ \\ {\tilde{p}}_{n} = P ( p , R , {p}_{n} )\end{matrix}$$

The example method provides a total of 2n equations and 6 unknowns (p, R). Accordingly, at least 3 sign points are needed to determine the vehicle position and orientation. As appreciated, although 3 sign points are utilized in this disclosed example, more points maybe utilized within the contemplation and scope of this disclosure.

Another disclosed example approach is to use one or more points of known locations and track those points over time as the vehicle moves. When points are tracked, it may be possible to utilize fewer than 3 points due to the use of a time history.

Vehicle relative motion is calculated, based on measured wheel rotations, steering wheel angle, vehicle speed, vehicle yaw rate, and possibly other vehicle data (e.g. IMU). The vehicle information is combined with a vehicle model. By combining the motion of the point(s) in the image with the relative motion of the vehicle, over time, the vehicle position and orientation can be determined. Once convergence to the correct position and orientation has occurred, the correct position and orientation can be maintained if the known points are still being tracked.

Another approach to solve this problem would be a Kalman filter or other nonlinear observer. The unknown states would be the vehicle position and orientation.

As mentioned earlier, a vehicle model could be used to predict future states from current states. The measurement would consist of the image coordinate(s) of the known point position(s) on the sign. Other methods also exist to solve this type of problem, such as nonlinear least squares or optimization methods.

The disclosed system enables camera and computer vision system to derive a precise position by viewing a sign and determining an offset from the sign.

In the above example embodiments, the vehicle 10 uses its computer vision-based algorithm to detect, recognize and interpret traffic signs, such as the road sign 14 having GPS coordinates registered in a database. The vehicle 10 uses the road/traffic sign 14 as a fixed reference and corrects its localization by computing its distance to the traffic sign 14 using its known geometry (projective geometry transform). The vehicle 10 can also detect the vehicle's localization. However, correcting the localization makes sense only if the map (predefined or constructed) of the environment is also reliable.

According to another example embodiment, the vehicle positioning system 15 includes a mapping algorithm or module which reconstructs a map, such as a three-dimensional (3D) point cloud map, for a region of interest around the road sign 14. The known fixed size of the road sign 14 is a parameter that gives information for reconstructing the map at scale. The mapping module may extend the region of interest to include the surroundings of the traffic sign 14, which allows for a better map as more information is provided. In one implementation, the mapping algorithm includes a point cloud generator which receives the images, i.e., image data, from the camera 12 of the vehicle 10 and generates a three dimensional (3D) point cloud based upon the received image data. The 3D point cloud may be sparse, semi-dense or dense. Generating the 3D point cloud includes executing a well known algorithm, such as a visual odometry (VO) algorithm, a simultaneous localization and mapping (SLAM) algorithm, or a structure from motion (SfM) algorithm. The 3D point cloud map is created from the generated 3D point cloud.

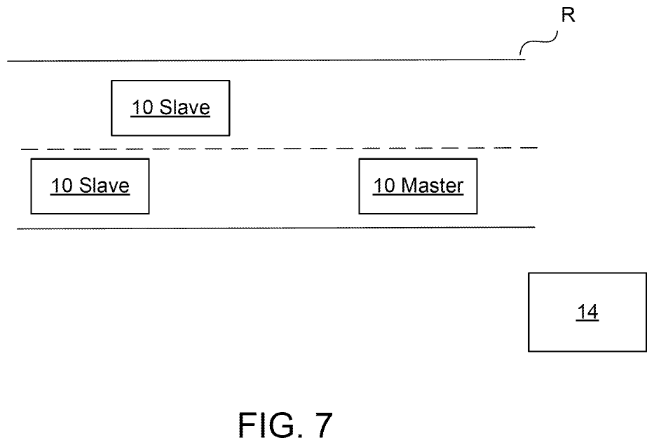

In this example embodiment, the vehicle positioning system 15 allows for collaboration with other vehicles in the same geographical area. For example, once the localization of the vehicle 10 is corrected and the map reconstructed, the vehicle 10, which either joins or had already joined a network or group of vehicles within a geographical area and/or communication range, acts as a master vehicle relative to the network and provides its updated data (i.e., localization data and/or reconstructed map) to the slave vehicles of the network which have not yet seen the road sign 14, or have only partially seen the extended region of interest including the sign. As the slave vehicles of the network see the road sign 14, such vehicles themselves may each become a master and update its localization and local map, and then may share their corresponding localization data and map with the rest of slave vehicles in the network/group. FIG. 7 is an illustration depicting a vehicle 10 serving as a master vehicle (from having updated and/or corrected its localization information) and plural vehicles 10 serving as slave vehicles.

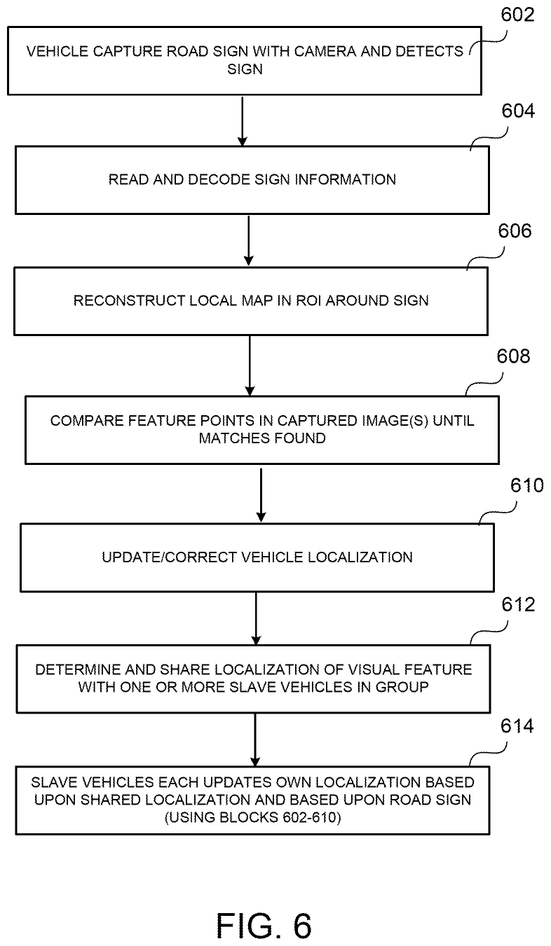

FIG. 6 depicts a flowchart describing an operation of the vehicle positioning system 15 for a vehicle 10 according to an example embodiment. As the vehicle 10 enters a GPS-denied environment, such as a tunnel, the camera 12 of the vehicle 10 captures images of the tunnel at 602, including the road sign 14 therein. A neural network of the vehicle 10 receives the captured images and detects at 602 representations of the road sign 14 in the images. Upon detection of the road sign 14 representation in the images, the controller 25 reads from the images the representation of the label 16 in the images. In one example, the QR code or other code is read from the images and decoded by the controller 25 at 604. The controller 25 reconstructs at a local map, such as a map in a region of interest surrounding the road sign 14 at 606. The local map is based upon the captured images which depict the road sign 14 therein. The local map may be a 3D point cloud map. In one implementation, the region of interest is larger than the road sign 14 and corresponds to the region depicted in the images captured by camera 12 that include a representation of road sign 14. With the fixed size of the road sign 14 being known, the map is reconstructed at scale. At 608, the controller 25 compares feature points in the captured images which include a representation of the road sign 14 with points in the reconstructed map. Upon finding at least a predetermined number of matches between the reconstructed map and points in the captured images that include a representation of the road sign 14, the controller 25 is able to update and/or correct the localization of the vehicle 10 at 610.

With continued reference to FIG. 6, the controller 25 determines a localization of one or more visual features of the vehicle at 612, based upon the updated/corrected localization performed at 610. The one or more visual features may include, for example, the mid-point of the rear plate of the vehicle 10. In addition, the controller 25 may share at 612 the localization information of the one or more visual feature of the vehicle 25 with neighboring vehicles, such as vehicles within communication range of the vehicle 10, using wireless vehicle-to-vehicle (V2V) and/or vehicle-to-everything (V2X) communication. Each vehicle which receives the localization information from the vehicle 10 may, at 614, may determine, correct and/or update its localization using the information shared by the (master) vehicle 10. For example, such a vehicle that has not yet seen the road sign 14 may be considered as a slave vehicle. If the slave vehicle receives the localization information from the vehicle 10 and also “sees” the road sign 14, the slave vehicle may correct and/or update its localization based upon the information associated with the road sign 14, as discussed above with respect to blocks 602-610, and based upon the localization information sent by the vehicle 10.

In another example embodiment, the road sign 14 is a “smart” sign and includes a controller and/or microcontroller having one or more processing cores as well as memory coupled thereto. The smart road sign 14 also includes a transducer (receiver and transmitter) to communicate with equipped vehicles such as the vehicle 10. This smart road sign 14 detects passing vehicles, computes the distances to the passing vehicles and sends the distance information as well as other information discussed above (e.g., coordinate information of the road sign 14) to the passing vehicles. A smart road sign computing the distances to passing vehicles and sharing same saves computational resources for the passing vehicles. In this case, the passing vehicles each compares its own localization information (from poor GPS and vehicle information) to what they receive from the smart road sign and may either correct/update its localization or reject the information received from the smart sign 14.

In addition, with the vehicle 10 being a smart vehicle and with the road sign 14 being a smart sign, the vehicle 10 may determine its localization as described above with respect to blocks 602-610 of FIG. 6, and may cross-validate its localization with the information provided by the smart road sign 14. This cross-validation may be used to prevent any flaws in the system, such as a smart road sign 14 that has been damaged or hacked.

Further, the vehicle 10 may determine its localization as described above with respect to blocks 602-610 while a similarly situated vehicle (relative to the road sign 14) does the same. The localization information may be shared between the two vehicles to cross-validate the information.

The vehicle positioning system 15 utilizes vehicle-to-everything (V2X) technologies to enable collaboration between a smart master vehicle 10 and neighboring slave vehicles. Even though the slave vehicles have not seen the road sign 14 or its markings, their position and maps may still be updated. Having a group of vehicles with more precise localization and mapping may improve the general landscape of the traffic in poor conditions in which position (GPS) information is lacking.

The vehicle positioning system 15 does not solely focus on synchronizing the coordinates frames between the vehicles and the infrastructure but also makes use of techniques to detect flaws in the system, allowing vehicles to decide to trust or not their own localization information.

Further, the vehicle positioning system 15 extends the region of interest and is not limited to a bounding box around the road sign 14. The use of the surrounding features of the road sign 14 to create a map adds more robustness and precision to the localization system, especially at longer distances. The system also does not rely only on the known size of the road sign 14 as using the features in the extended region of interest and match them to a pre-existing map allow to retrieve the scale more precisely.

The vehicle positioning system 15 provides increased reliability as more information is shared from multiple sources with which a vehicle 10 may localize. The system provides improved flexibility with the vehicles and/or the road sign 14 are smart devices. As mentioned, a smart road sign 14 allows vehicles to devote its computational resources for other vehicular operations.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A vehicle localization system for a vehicle, comprising:
a camera disposed on a vehicle for reading an optic label disposed on fixed object and capturing an image of a shape also disposed on the fixed object;
a controller configured to update location information of the vehicle based on perspective dimensions of the shape captured by the camera and actual dimensions of the shape read from the optic label, and to share the location information of the vehicle with one or more neighboring vehicles.

2. The vehicle localization system as recited in claim 1, wherein the optic label includes coordinates of the fixed object and the controller is operable to determine a position of the vehicle based on a determined distance and orientation of the vehicle relative to the fixed object and the coordinates of the fixed object, the location information comprising the position of at least one visible feature of the vehicle.

3. The vehicle localization system as recited in claim 1, wherein the controller is further configured to receive location information from one or more of the neighboring vehicles, identify in image data from the camera a representation of the one or more neighboring vehicles, and selectively further update the location information of the vehicle based upon the location information received from the one or more of the neighboring vehicles and the representation of the one or more neighboring vehicles.

4. The vehicle localization system as recited in claim 3, wherein controller is further configured to determine whether or not to update the location information of the vehicle based upon the location information received from the one or more of the neighboring vehicles, and the further update of the location information of the vehicle is in response to the determination of whether or not to update the location information of the vehicle.

5. The vehicle localization system as recited in claim 3, wherein the location information from the one or more of the neighboring vehicles is relative to a second fixed object having an optic label disposed thereon.

6. The vehicle localization system as recited in claim 1, wherein the location information comprises a local map of a region of interest surrounding the fixed object, the region of interest being larger than the fixed object.

7. The vehicle localization system as recited in claim 1, wherein the controller is further configured to receive from the fixed object second location information of the vehicle relative to the fixed object, the second location information comprising distance information between the fixed object and the vehicle as measured by the fixed object, and to selectively update the location information based upon the second location information.

8. The vehicle localization system as recited in claim 1, wherein the controller includes or is associated with non-transitory memory having program code instructions which, when executed by the controller, causes the controller to update the location information and to share the updated location information with the neighboring vehicles.

9. A vehicle localization program code product stored in non-transitory memory having instructions which, when executed by a controller having a processor, causes the controller to perform a method comprising:
capturing image data from at least one camera disposed on a vehicle;
identifying a representation of a second vehicle in the image data;
receiving, from the second vehicle, location information corresponding to the second vehicle; and
determining or updating location information of the vehicle based on the representation of the second vehicle in the image data and the location information for the second vehicle.

10. The program code product of claim 9, wherein the image data includes a shape of a representation of a fixed object, wherein updating location information of the vehicle is based on perspective dimensions of the shape of the fixed object representation captured by the camera and actual dimensions of the shape read from an optic label disposed on the fixed object; and wherein the method further comprises sharing the location information of the vehicle with one or more neighboring vehicles, the location information comprising location information of at least one visible feature of the vehicle.

11. The vehicle localization code product of claim 10, wherein the location information comprises a local map of a region of interest surrounding the fixed object, the region of interest being larger than the fixed object.

12. The vehicle localization code product of claim 9, wherein the method further comprises determining whether or not to update the location information of the vehicle based upon the location information received from the second vehicle, and updating the location information of the vehicle in response to the determination of whether or not to update the location information of the vehicle.

13. The vehicle localization code product of claim 9, wherein the location information of the second vehicle comprises localization information for a visible feature of the second vehicle.

14. The vehicle localization code product of claim 9, wherein the method further comprises sharing the location information of the vehicle with one or more neighboring vehicles.

15. A vehicle localization method for a vehicle, the method comprising:
capturing image data from at least one camera disposed on a vehicle;
identifying a representation of a second vehicle in the image data;
receiving, from the second vehicle, location information corresponding to the second vehicle; and
determining or updating location information of the vehicle based on the representation of the second vehicle in the image data and the location information for the second vehicle.

16. The method of claim 15, wherein the image data includes a shape of a representation of a fixed object, wherein updating location information of the vehicle is based on perspective dimensions of the shape of the fixed object representation captured by the camera and actual dimensions of the shape read from an optic label disposed on the fixed object, and wherein the method further comprises sharing the location information of the vehicle with one or more neighboring vehicles.

17. The method of claim 15, wherein the location information of the second vehicle comprises localization information for a visible feature of the second vehicle.

18. The method of claim 15, wherein the method further comprises sharing the location information of the vehicle with one or more neighboring vehicles.
